(19) United States
(12) Patent Application Publication
(10) Pub. No.: US 2020/0410398 A1
(43) Pub. Date: Dec. 31, 2020

(54) Methods and Devices for Chunk Based IoT Service Inspection

(71) Applicant: TELEFONAKTIEBOLAGET LM ERICSSON (PUBL), STOCKHOLM (SE)

(72) Inventors: Ting Zhu, SHANGHAI (CN); Yizong MENG, SHANGHAI (CN); Xiaojun YIN, Shanghai (CN); Huoming DONG, Shanghai (CN)

(21) Appl. No.: 16/976,134

(22) PCT Filed: Mar. 20, 2019
(86) PCT No.: PCT/CN2019/078912

§ 371 Date: Aug. 27, 2020

(30) Foreign Application Priority Data
Mar. 23, 2018 (CN) PCT/CN2018/080259

(51) Int. Cl. G06N 20/00; G06K 9/62; H04L 29/08; G16Y 30/00; G16Y 40/35

(52) U.S. Cl. CPC G06N 20/00; G06K 9/6218; G16Y 40/35; H04L 67/12; G16Y 30/00; G06K 9/6259

(57) ABSTRACT

A method for chunk based lot service inspection is provided. The method is implemented by a network device in a communication network. Data of IoT service may be received. The data may include a plurality of packets from a network node. The plurality of packets may be shaped into one or more chunks based on packet header information of each packet. Each chunk may include one or more packets. One or more characteristic parameters for each of the one or more chunks may be generated based on one or more properties of the one or more packets in said chunk. A cluster label may be identified for each chunk based on shaping the plurality of packets into one or more the one or more characteristic parameters of said chunk.

### TECHNICAL FIELD

The present disclosure generally relates to service inspection, and more specifically to methods and devices for chunk based Internet of Things (IoT) service inspection.

### BACKGROUND

Today various types of services are transmitted on communication networks. Usually, different quality requirements are applied for different types of services. In a 3GPP system, it is necessary for an operator to recognize data for different types of services in order to manage resource allocation, service policy and quality requirement for different services.

With the development IoT, there are more and more encrypted or proprietary traffic because of various types of vertical industries and network security. Therefore, there is a need to identify different encrypted, unknown or proprietary IoT services for operators, since different IoT services may have different resource, service quality and priority requirements.

### SUMMARY

It is an object of the present disclosure to address the problem mentioned above.

According to a first aspect of the present disclosure, there is provided a method implemented by a network device in a communication network. Data of IoT service may be received. The data may include a plurality of packets from a network node. The plurality of packets may be shaped into one or more chunks based on packet header information of each packet. each chunk including one or more packets. One or more characteristic parameters for each of the one or more chunks may be generated based on one or more properties of the one or more packets in said chunk. A cluster label may be identified for each chunk based on the one or more characteristic parameters of said chunk.

According to a second aspect of the present disclosure, there is provided a network device in a communication network. The network device may comprise a processor and a memory communicatively coupled to the processor. The memory may be adapted to store instructions which, when executed by the processor, cause the network device to perform steps of the method according to the above first aspect.

According to the third aspect of the present disclosure, there is provided a non-transitory machine-readable medium having a computer program stored thereon. The computer program, when executed by a set of one or more processors of a network device, causes the network device to perform steps of the method according to the above first aspect.

The present disclosure provides a method and device for chunk based service inspection. With the disclosure, services transmitted over a communication network will be inspected without deep inspection for packets, thus more conveniently and effectively identifying the service. By means of the technical solution in the present disclosure, network services may be classified efficiently, even without knowledge of their protocol, thus different types of network service can be assigned appropriate network resources, such that network resources may be utilized efficiently.

### BRIEF DESCRIPTION OF THE DRAWINGS

The present disclosure may be best understood by way of example with reference to the following description and accompanying drawings that are used to illustrate embodiments of the present disclosure. In the drawings:

FIG. 1 schematically illustrates a block diagram for conventional service inspection in a communication network;

FIG. 2 schematically illustrates an exemplary flow diagram of a method for chunk based IoT service inspection implemented by a network device according to one or more embodiments of the present disclosure;

FIG. 3 illustrates a block diagram for chunk based IoT service inspection using a semi-supervised ML algorithm according to one or more embodiments of the present disclosure;

FIG. 4 illustrates a comparison between the cluster result for using unsupervised ML algorithm and using semi-supervised ML algorithm;

FIG. 5 schematically illustrates an exemplary flow diagram of a method for generating a cluster model, which includes a plurality of clusters, based on IoT service data according to one or more embodiments of the present disclosure;

FIG. 6 illustrates an exemplary flow diagram of a method for building a cluster model using a semi-supervised ML algorithm based on training data according to the one or more embodiments of the present disclosure;

FIG. 7 schematically illustrates an exemplary flow diagram for a method for identifying a cluster label for a chunk of real IoT service data based on a cluster model according to one or more embodiments of the present disclosure; and

FIG. 8 is a block diagram illustrating a network device according to some embodiments of the present disclosure.

### DETAILED DESCRIPTION

The following detailed description describes methods and apparatuses for energy saving in communication network. In the following detailed description, numerous specific details such as logic implementations, types and interrelationships of system components, etc. are set forth in order to provide a more thorough understanding of the present disclosure. It should be appreciated, however, by one skilled in the art that the present disclosure may be practiced without such specific details. In other instances, control structures, circuits and instruction sequences have not been shown in detail in order not to obscure the present disclosure. Those of ordinary skill in the art, with the included descriptions, will be able to implement appropriate functionality without undue experimentation.

As used herein, the terms “first”, “second” and so forth refer to different elements. The singular forms “a”, “an”, and “the” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “according to” is to be read as “at least in part according to”. The term “one embodiment” and “an embodiment” are to be read as “at least one embodiment”. The term “another embodiment” is to be read as “at least one other embodiment”.

Unless otherwise defined, all terms (including technical and scientific terms) used herein have the same meanings as commonly understood. It will be further understood that a term used herein should be interpreted as having a meaning consistent with its meaning in the context of this specification and the relevant art and will not be interpreted in an idealized or overly formal sense unless expressly so defined herein.

Bracketed text and blocks with dashed borders (e.g., large dashes, small dashes, dot-dash, and dots) may be used herein to illustrate optional operations that add additional features to embodiments of the present disclosure. However, such notation should not be taken to mean that these are the only options or optional operations, and/or that blocks with solid borders are not optional in certain embodiments of the present disclosure.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on, that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of or one or more physical network interfaces to establish network connections (to transmit and/or receive code and/or data using propagating signals) with other electronic devices. One or more parts of an embodiment of the present disclosure may be implemented using different combinations of software, firmware, and/or hardware.

A network device is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

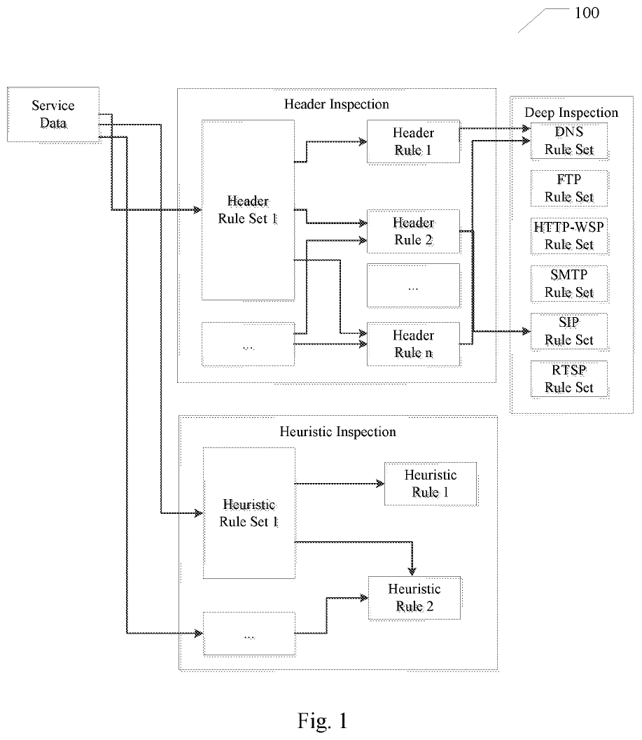

FIG. 1 schematically illustrates a block diagram for conventional service inspection in a communication network. Typically, there are three kinds of service detection method, such as Header Packet Inspection, Deep Packet Inspection and Heuristic Packet Inspection.

Header Packet Inspection consists of inspection of layers 3 and 4, and it is based on the 5-tuple of the IP packet header, such as Source IP address, Destination IP address, Source TCP or User Datagram Protocol port number, Destination TCP or UDP port number and Protocol type. The packets can be classified into a flow based on the 5-tuple. However, header packet inspection is unable to identify specific service, such as Web, Video or VoIP.

Deep Packet Inspection is used for specific service identification, which consists of inspection of layers 4 through 7. However, the protocol type must be known in DPI method and DPI uses knowledge of the protocol definition and IP payload for inspection of specific service, such as Domain Name System (DNS), File Transfer Protocol (FTP), HyperText Transfer Protocol (HTTP) or Session Initiation Protocol (SIP) protocol.

Heuristic packet inspection is oriented to the integral detection of complete services or applications when Deep Packet Inspection is not possible because of the new or unknown protocol, proprietary or encrypted protocol. Heuristic packet inspection is based on a set of empirical patterns that are characteristic of a specific protocol or application, e.g. inspection from known IP address or URL identification, or inspection from protocol pattern or metrics identification. The Heuristic packet inspection may be used for inspection of file-transfer service, such as bit-torrent, e-donkey, or VoIP service, such as skype, etc.

Heuristic rules provide best effort inspection and are used mainly for policy control or statistical purposes, whereas header packet inspection and DPI rules are used mainly for charging.

However, such service inspection methods described above are all packet based, which knowledge of protocol type or protocol pattern should be required by extracting information from packets. Therefore, when the protocol type or protocol pattern is unknown, such service inspection methods may not function.

With the development IoT, there are more and more encrypted or proprietary traffic because of various types of vertical industries and network security. Therefore, the identification of encrypted, unknown or proprietary IoT network application traffic (proportion estimated to be 70%) is necessary for an operator to manage resource allocation, service quality for each service. However, the protocol types for most of the services are unknown or encrypted, and it will be exhausting for an operator to establish a protocol pattern for each type of the services. Thus, there is a need to propose an efficient solution to identify different encrypted, unknown or proprietary IoT services for operators, so that the resource allocation, service policy, and service quality may be managed by the operator.

The present disclosure provides a method for chunk-based service inspection using a semi-supervised machine learning (ML) algorithm. Normally, supervised ML algorithm may be applied for service identification, e.g. KNN (k-NearestNeighbor), when all service data has descriptive characters or labels. However, for data without service labels, unsupervised ML algorithm may be applied, e.g. K-means. The present disclosure provides a method using a semi-supervised ML algorithm which combines supervised ML and unsupervised ML, so that the method may provide more accurate inspection result in the case that not all service data has labels.

As used herein, “machine learning algorithm” may refer to an algorithm to learn a model that maps input to output based on training data, in which “supervised” would be that the training data may have predefined labels, and “unsupervised” would be that the labels for training data may be unknown. As used herein, a “chunk” is a collection of one or more packets transmitted over a communication network. A chunk may be grouped based on IP 5-tuple information in packet header information.

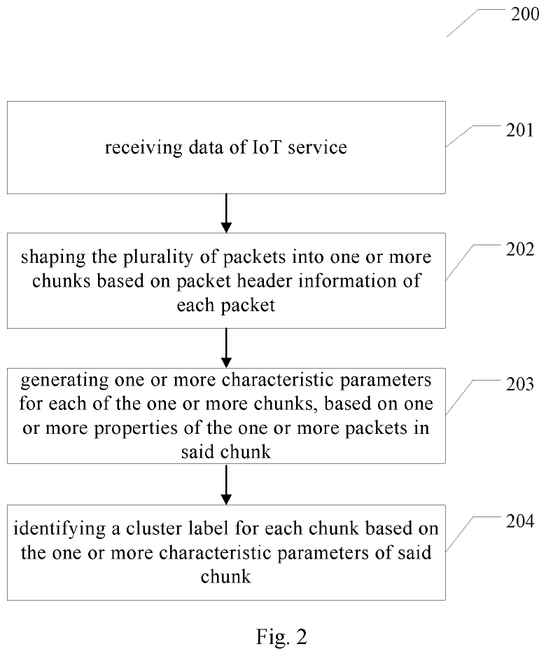

FIG. 2 schematically illustrates an exemplary flow diagram of a method 200 for chunk based IoT service inspection implemented by a network device according to one or more embodiments of the present disclosure.

Referring to FIG. 2, in step 201, data of IoT service is received, wherein the data including a plurality of packets from a network node. In step 202, the plurality of packets is shaped into one or more chunks based on packet header information of each packet, each chunk may include one or more packets. As an example, the packet header information may include source address, destination address, source port number, destination port number, and protocol type, such as TCP or UDP. In step 203, one or more characteristic parameters for each of the one or more chunks are generated based on one or more properties of the one or more packets in said chunk. As an example, the one or more properties may comprise packet size, packet interarrival, and packet latency. The one or more properties may be accumulated statistically, and the one or more characteristic parameters may include at least one of: Packet count, Packet Average Size, Packet Maximum Size, Packet Minimum Size, Packet Sum Size, Packet Average Interarrival, Packet Maximum Interarrival, Packet Minimum Interarrival, Packet Sum Interarrival, First Quartile of Packet Size, Median of Packet Size, Third Quartile of Packet Size, Variance of Packet Size, First Quartile of Packet Size Trend, Median of Packet Size Trend, Third Quartile of Packet Size Trend, First Quartile of Packet Interarrival, Median of Packet Interarrival, Third Quartile of Packet Interarrival, Variance of Packet Interarrival, First Quartile of Packet Interarrival Trend, Median of Packet Interarrival Trend, and Third Quartile of Packet Interarrival Trend, Packet Average Latency, Packet Maximum Latency, Packet Minimum Latency, Packet Sum Latency, which are related to one or more of the above properties. In step 204, a cluster label is identified for each chunk based on the one or more characteristic parameters of said chunk.

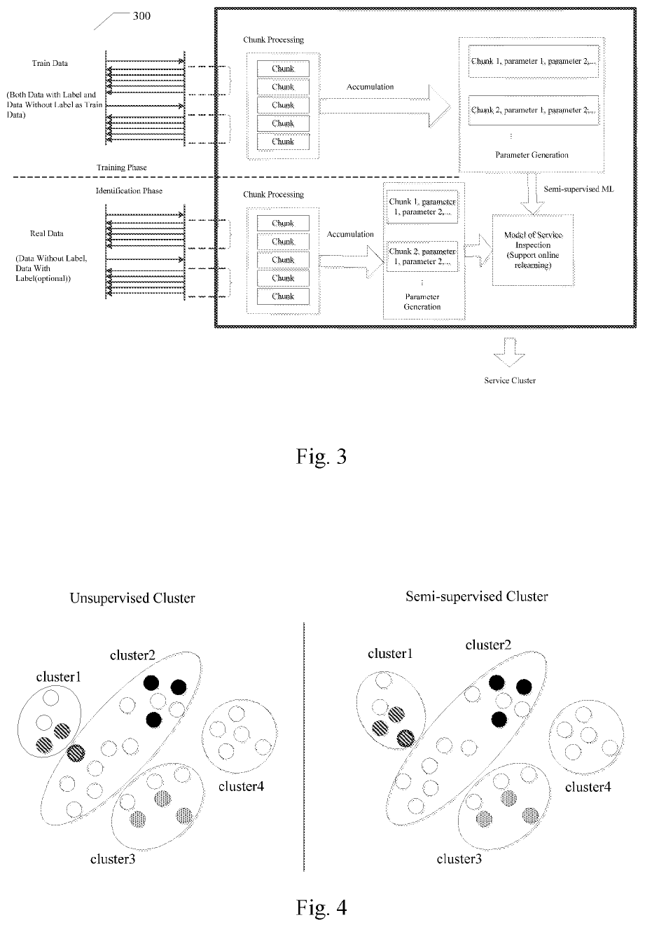

FIG. 3 illustrates a block diagram for chunk based IoT service inspection using a semi-supervised ML algorithm according to one or more embodiments of the present disclosure. The method for chunk based IoT service inspection may be divided in to two phases, i.e. a training phase, and an identification phase.

In the training phase, some training data for IoT service may be obtained and be provided to a chunk processing block, wherein the training data includes packets with known labels and packets without labels. Then, one or more packets of the training data may be shaped into one or more chunks based on packet header information for each packet by the chunk processing block. As an example, the packet header information may include IP 5-tuple of IP packet, including Source IP Address, Destination IP Address, Source Port, Destination Port, and Protocol Type, such as Transmission Control Protocol (TCP) or User Datagram Protocol (UDP).

Packets without labels may include packets which belong to unknown IoT service and packets which belong to known IoT service but have not been labeled. As an example, the training data may include packets with service tags and packets without service tags. A service tag is a tag for specific IoT service, such as video monitoring service, auto driving service, intelligent health service, intelligent furniture service, retail POS service, power meter service, tracing service or the like. In an embodiment, a cluster may contain chunks of different IoT services. That is, different service tags may be mapped to a same cluster label. As an example, each packet of data with a service tag may be allocated a predefined cluster label based on the service tag. As another example, each chunk of data with a service tag may be allocated a predefined cluster label based on the service tag.

Then, the one or more chunks may be processed to generate one or more characteristic parameters for each chunk based on the one or more properties of the one or more packets in each chunk. As an example, the one or more properties of the one or more packets in each chunk may be accumulated statistically. Then, a cluster model comprising a plurality of clusters may be built based on the one or more characteristic parameters for each chunk of the one or more chunks using a semi-supervised ML algorithm. The method for building a cluster model using a semi-supervised ML algorithm may be described in more details below. A semi-supervised ML algorithm is a combination of an unsupervised ML algorithm and a supervised ML algorithm.

In an embodiment, IoT service may be classified based on one or more properties of packets in the IoT service, such as packet size, interarrival, and latency. As used herein, “packet size” may refer to the size of a packet in the IoT service, which may be in Bytes, “interarrival” may refer to the time duration between the arrival of two successive packets, and “latency” may refer to the time duration between a request packet and a corresponding response packet, the latency may also referred as “response latency” here. Thus, the training data may be divided into 8 clusters by these three properties, for example, small packets is less then 60B, short interarrival is second level or less, and short latency is 50 ms or less. Then, the eight clusters may be defined as follows:
1. Big packet size, long interarrival, and long latency;
2. Big packet size, long interarrival, and short latency;
3. Big packet size, short interarrival, and long latency;
4. Big packet size, short interarrival, and short latency;
5. Small packet size, long interarrival, and long latency;
6. Small packet size, long interarrival, and short latency;
7. Small packet size, short interarrival, and long Latency;
8. Small packet size, short interarrival, and short Latency.

However, such number is merely an illustrative example, but not limiting. The skilled person in the art may define different number of clusters to which the IoT service is divided according to a specific implementation. In other embodiments, other properties may be used to classify IoT service.

The characteristic parameters used to identify a cluster label for a chunk may include at least one of: Packet count, Packet Average Size, Packet Maximum Size, Packet Minimum Size, Packet Sum Size, Packet Average Interarrival, Packet Maximum Interarrival, Packet Minimum Interarrival, Packet Sum Interarrival, First Quartile of Packet Size, Median of Packet Size, Third Quartile of Packet Size, Variance of Packet Size, First Quartile of Packet Size Trend, Median of Packet Size Trend, Third Quartile of Packet Size Trend, First Quartile of Packet Interarrival, Median of Packet Interarrival, Third Quartile of Packet Interarrival, Variance of Packet Interarrival, First Quartile of Packet Interarrival Trend, Median of Packet Interarrival Trend, and Third Quartile of Packet Interarrival Trend, Packet Average Latency, Packet Maximum Latency, Packet Minimum Latency, Packet Sum Latency. As used herein, “quartile” is a statistical term describing a division of observations into four defined intervals based upon the values of the data and how they compare to the entire set of observations. The first quartile is defined as the middle number between the smallest number and the median of the data set. The second quartile is the median of the data. The third quartile is the middle value between the median and the highest value of the data set. “Trend” as used herein is change between the previous value and the latter value, which maybe positive or negative.

FIG. 4 illustrates a comparison between the cluster result for using unsupervised ML algorithm and using semi-supervised ML algorithm. In FIG. 4, the circles with different colors refer to different IoT services with different known tags, and the blank circles refer to chunks for IoT services without tags. The left part of FIG. 4 illustrates a cluster result for using unsupervised ML algorithm. As seen in FIG. 4, the hatched circle refers to a chunk with a cluster label of cluster 1, the black circle refers to a chunk with a cluster label of cluster 2, and the dotted circle refers to a chunk with a cluster label of cluster. Two hatched circles are identified as cluster 1, and one hatched circle is identified as cluster 2. There is one hatched circle mistakenly identified as cluster 2. By using a semi-supervised ML algorithm, since the hatched circle is predefined as cluster 1, when the identified cluster label (cluster 2) is not consistent with the predefined cluster label (cluster 1), the cluster label for that chunk may be replaced with the predefined cluster label, i.e. cluster 1, so that the cluster result is more accurate. The number of clusters and the cluster result are merely illustrative examples, the skilled person in the art may utilize different numbers of clusters and obtain different cluster result according to different implementations.

It is also noted that the generated cluster model could not only suit for IoT services but be applicable to traditional types of service other than IoT. Training data input to the chunk processing block may also comprise the traditional types of service, so as to form characteristic parameters which contribute to the cluster model. Thus, in identification phase, real data of traditional types of service can also be classified into clusters with cluster label. For simplicity, only data of IoT service is mentioned in embodiments of the disclosure, while data of other type of services also apply.

Turning back to FIG. 3, in the identification phase, some real IoT service data may be received online, and be provided to the chunk processing block. One or more packets of the real IoT service data may be shaped into one or more chunks by the chunk processing block. The real IoT service data may be all data without service tags. As an alternative embodiment, the real IoT service data may include packets with services tags and packets without service tags both. Then, the one or more chunks may be processed to generate one or more characteristic parameters for each chunk based on the one or more properties of the one or more packets in each chunk. As an example, the one or more properties of the one or more packets in each chunk may be accumulated statistically. Then, a cluster label may be identified for each chunk based on the one or more characteristic parameters using a cluster model. As an embodiment, a chunk of the real IoT service data may be allocated a predefined cluster label based on the service tags for one or more packets in the chunk. If the allocated cluster label is not consistent with the predefined cluster label for a chunk of the IoT service, the identified cluster label may be replaced with the predefined cluster label for the chunk. Then, the cluster model used for identifying a cluster label for each chunk may be adjusted according to the predefined cluster label online. As an alternative embodiment, the cluster model may be adjusted offline using a semi-supervised ML algorithm, if the inconsistence between the predefined cluster label and the identified cluster label for a chunk exceeds a threshold. Then, the adjusted cluster model may be used to identify cluster label for IoT service online again.

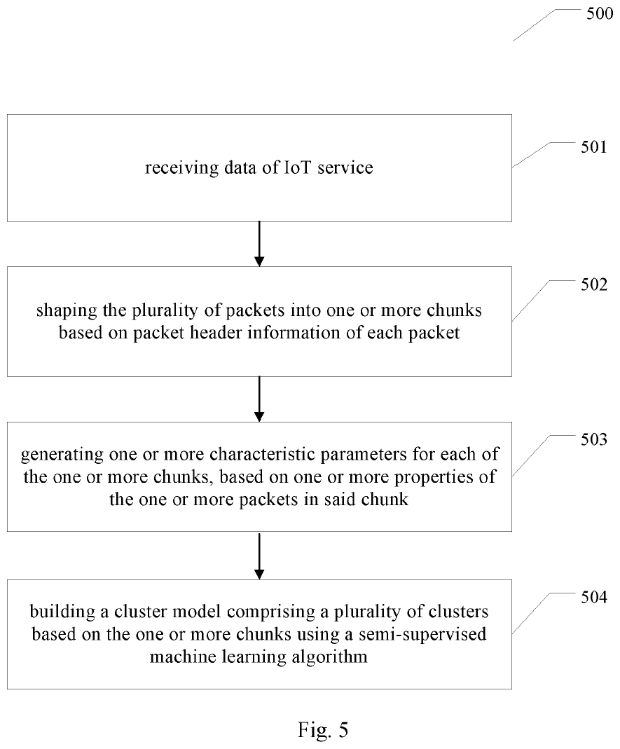

FIG. 5 schematically illustrates an exemplary flow diagram of a method 500 for generating a cluster model, which includes a plurality of clusters, based on IoT service data according to one or more embodiments of the present disclosure. The cluster model can be used to identify a cluster label for received IoT service data online.

Referring to FIG. 5, in step 501, data of IoT service may be received, wherein the data including a plurality of packets from a network node. In step 502, the plurality of packets may be shaped into one or more chunks based on packet header information of each packet, each chunk may include one or more packets. In step 503, one or more characteristic parameters for each of the one or more chunks may be generated based on one or more properties of the one or more packets in said chunk. In step 504, the cluster model may be built based on the one or more chunks using a semi-supervised machine learning algorithm, wherein some of the one or more chunks having predefined cluster labels. The method for building a cluster model using a semi-supervised ML algorithm may be described in more details below.

Many different ways of executing the method are possible, as will be apparent to a person skilled in the art. For example, the order of the steps can be varied or some steps may be executed in parallel. Moreover, in between steps other method steps may be inserted. The inserted steps may represent refinements of the method such as described herein, or may be unrelated to the method. For example, steps may be executed, at least partially, in parallel. A given step may not have finished completely before a next step is started. Moreover, fewer than all the illustrated steps may be required to implement an example methodology. Steps may be combined or separated into multiple sub-steps. Furthermore, additional or alternative methodologies can employ additional, not illustrated steps.

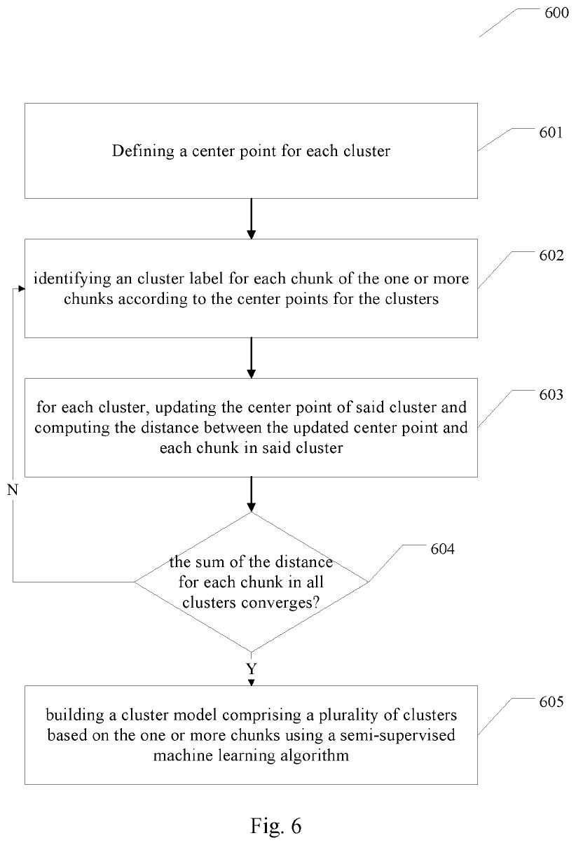

FIG. 6 illustrates an exemplary flow diagram of a method 600 for building a cluster model using a semi-supervised ML algorithm according to the one or more embodiments of the present disclosure.

Referring to FIG. 6, in step 601, a center point may be initially defined for each cluster. The initial center point may be predefined or even randomly allocated. In step 602, a cluster label may be identified for each chunk of the one or more chunks according to the center points for the clusters. In step 603, for each cluster, the center point of said cluster may be updated and the distance between the center point and each chunk in said cluster may be computed. Then, in step 604, it is determined whether the sum of the distance for each chunk in all clusters converges. If the sum of the distance for each chunk in all clusters converges, the cluster model may be generated, in step 605. Otherwise, the method may return to step 602 to identify a cluster label for each chunk according to the updated center point.

According to an embodiment, each chunk of data with service tag may be allocated a label based on the service tag, thus the chunks may include labeled chunks and unlabeled chunks. The labeled chunks may be divided into a plurality of labeled clusters based on their labels. Then, the center point for a labeled cluster may be predefined, such as by averaging all chunks in said labeled cluster. The unlabeled chunk which is furthest away from the center points for labeled clusters may be selected as a center point for an unlabeled cluster. Assuming that the number of all clusters to which the chunks may be divided is K, the number for labeled clusters is L, then the number for unlabeled clusters is K-L. Thus, the top L unlabeled chunks which are furthest away from the center points for labeled clusters may be selected as the center points for unlabeled clusters. According to another embodiment, the center points for the K clusters may be selected from the chunks regardless of the labels.

The method illustrated in FIG. 6 is merely by way of example, but not limiting. Many different ways of executing the method are possible, as will be apparent to a person skilled in the art. For example, the skilled person in the art may utilize different semi-supervised algorithms to build a cluster model.

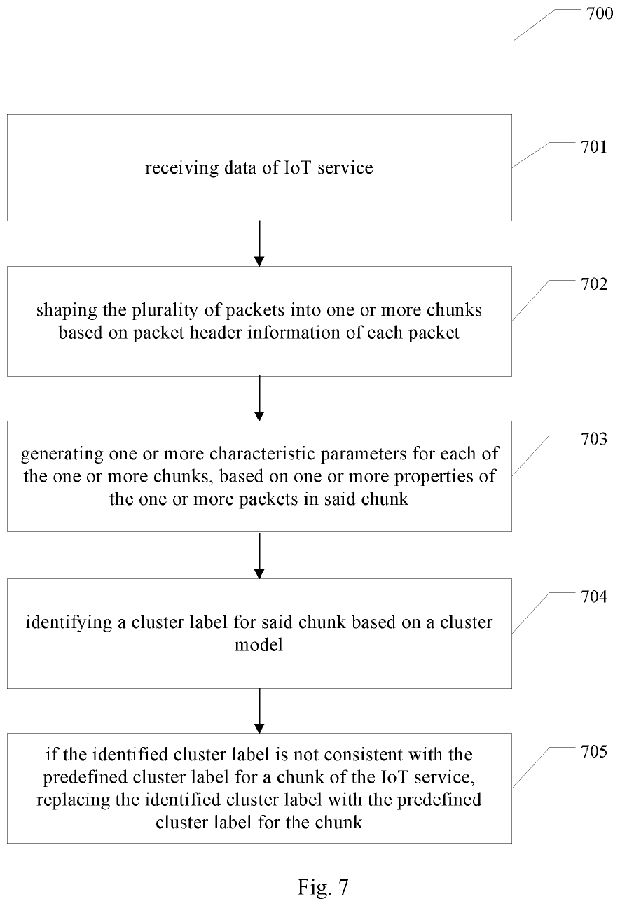

FIG. 7 schematically illustrates an exemplary flow diagram for a method 700 for identifying a cluster label for a chunk of real IoT service data according to one or more embodiments of the present disclosure.

Referring to FIG. 7, in step 701, data of IoT service may be received, wherein the data including a plurality of packets from a network node. As an example, the data of IoT service may be real service data transmitted online. In step 702, the plurality of packets may be shaped into one or more chunks based on packet header information (which is not necessarily located at the packet head) of each packet, each chunk may include one or more packets. In step 703, one or more characteristic parameters for each of the one or more chunks may be generated based on one or more properties of the one or more packets in said chunk. As an example, a predefined cluster label may be allocated for each chunk of data with a service tag based on the service tag for IoT service. In step 704, a cluster label may be identified for said chunk based on a cluster model. The cluster model may be related to the one or more characteristic parameters. Optionally, in step 705, if the identified cluster label is not consistent with the predefined cluster label for a chunk of the IoT service, the identified cluster label may be replaced with the predefined cluster label for the chunk.

For simplicity of explanation, the methodology described in conjunction with FIGS. 2-7 is depicted and described as a series of acts. It is to be understood and appreciated that aspects of the subject matter described herein are not limited by the acts illustrated and/or by the order of acts. In one embodiment, the acts occur in an order as described above. In other embodiments, however, two or more of the acts may occur in parallel or in another order. In other embodiments, one or more of the actions may occur with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

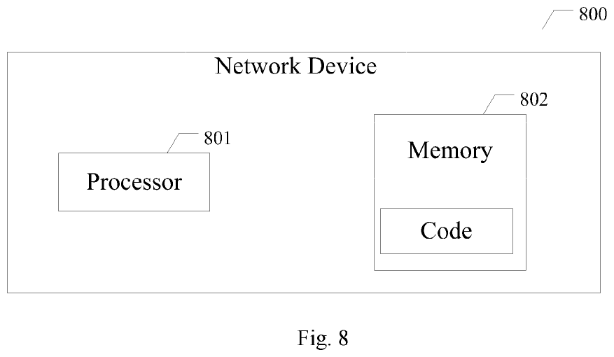

FIG. 8 is a block diagram illustrating a network device 800 according to some embodiments of the present disclosure. It should be appreciated that the network device 800 may be implemented using components other than those illustrated in FIG. 8.

With reference to FIG. 8, the network device 800 may comprise at least a processor 801, a memory 802, an interface and a communication medium. The processor 801, the memory 802 and the interface are communicatively coupled to each other via the communication medium.

The processor 801 includes one or more processing units. A processing unit may be a physical device or article of manufacture comprising one or more integrated circuits that read data and instructions from computer readable media, such as the memory 802, and selectively execute the instructions. In various embodiments, the processor 801 is implemented in various ways. As an example, the processor 802 may be implemented as one or more processing cores. As another example, the processor 801 may comprise one or more separate microprocessors. In yet another example, the processor 801 may comprise an application-specific integrated circuit (ASIC) that provides specific functionality. In yet another example, the processor 801 provides specific functionality by using an ASIC and by executing computer-executable instructions.

The memory 802 includes one or more computer-usable or computer-readable storage medium capable of storing data and/or computer-executable instructions. It should be appreciated that the storage medium is preferably a non-transitory storage medium.

The communication medium facilitates communication among the processor 801, the memory 802 and the interface. The communication medium may be implemented in various ways. For example, the communication medium may comprise a Peripheral Component Interconnect (PCI) bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing System Interface (SCSI) interface, or another type of communications medium. The interface could be coupled to the processor. Information and data as described above in connection with the methods may be sent via the interface.

In the example of FIG. 8, the instructions stored in the memory 802 may include those that, when executed by the processor 801, cause the network device 800 to implement the methods described with respect to FIGS. 2-7.

Some portions of the foregoing detailed description have been presented in terms of algorithms and symbolic representations of transactions on data bits within a computer memory. These algorithmic descriptions and representations are ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be appreciated, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to actions and processes of a computer system, or a similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present disclosure are not described with reference to any particular programming language. It should be appreciated that a variety of programming languages may be used to implement the teachings of embodiments of the present disclosure as described herein.

An embodiment of the present disclosure may be an article of manufacture in which a non-transitory machine-readable medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In the foregoing detailed description, embodiments of the present disclosure have been described with reference to specific exemplary embodiments thereof. It will be evident that various modifications may be made thereto without departing from the spirit and scope of the present disclosure as set forth in the following claims. The specification and drawings are, accordingly, to be regarded in an illustrative sense rather than a restrictive sense.

Throughout the description, some embodiments of the present disclosure have been presented through flow diagrams. It should be appreciated that the order of transactions and transactions described in these flow diagrams are only intended for illustrative purposes and not intended as a limitation of the present disclosure. One having ordinary skill in the art would recognize that variations can be made to the flow diagrams without departing from the spirit and scope of the present disclosure as set forth in the following claims.

1. A method implemented by a network device in a communication network, the method comprising:
receiving data of IoT service, wherein the data including a plurality of packets from a network node;
shaping the plurality of packets into one or more chunks based on packet header information of each packet, each chunk including one or more packets;
generating one or more characteristic parameters for each of the one or more chunks, based on one or more properties of the one or more packets in said chunk; and
identifying a cluster label for each chunk based on the one or more characteristic parameters of said chunk.

2. The method of claim 1, wherein the packet header information including source address, destination address, source port number, destination port number, and protocol type.

3. The method of claim 1, wherein the one or more properties comprises: packet size, packet interarrival, and packet latency.

4. The method of claim 3, wherein generating one or more characteristic parameters for each of the one or more chunks comprising accumulating statistically the one or more properties to generate at least one of the following for each chunk:
Packet count, Packet Average Size, Packet Maximum Size, Packet Minimum Size, Packet Sum Size, Packet Average Interarrival, Packet Maximum Interarrival, Packet Minimum Interarrival, Packet Sum Interarrival, First Quartile of Packet Size, Median of Packet Size, Third Quartile of Packet Size, Variance of Packet Size, First Quartile of Packet Size Trend, Median of Packet Size Trend, Third Quartile of Packet Size Trend, First Quartile of Packet Interarrival, Median of Packet Interarrival, Third Quartile of Packet Interarrival, Variance of Packet Interarrival, First Quartile of Packet Interarrival Trend, Median of Packet Interarrival Trend, and Third Quartile of Packet Interarrival Trend, Packet Average Latency, Packet Maximum Latency, Packet Minimum Latency, Packet Sum Latency.

5. The method of claim 1, wherein identifying a cluster label for each chunk based on the one or more characteristic parameters of said chunk comprising:
identifying a cluster label for said chunk based on a cluster model, the cluster model being related to the one or more characteristic parameters.

6. The method of claim 1, generating one or more characteristic parameters for each of the one or more chunks further comprising:
allocating a predefined cluster label for each chunk of data with a service tag based on the service tag for IoT service.

7. The method of claim 6, further comprising:
if the identified cluster label is not consistent with the predefined cluster label for a chunk of the IoT service, replacing the identified cluster label with the predefined cluster label for the chunk.

8. The method of claim 1, identifying a cluster label for each chunk based on the one or more characteristic parameters of said chunk comprising:
building a cluster model comprising a plurality of clusters based on the one or more chunks using a semi-supervised machine learning algorithm, wherein some of the one or more chunks having predefined cluster labels.

9. The method of claim 8, building a cluster model comprising a plurality of clusters comprising:
defining a center point for each of the clusters;
identifying an cluster label for each chunk of the one or more chunks according to the center points for the clusters;
for each cluster, updating the center point of said cluster and computing the distance between the updated center point and each chunk in said cluster;
determining whether the sum of the distance for each chunk in all clusters converges; and
if the sum of the distance for each chunk in all clusters converges, generating the cluster model.

10. A network device in a communication network, comprising:
a processor; and
a memory communicatively coupled to the processor and adapted to store instructions which, when executed by the processor, cause the network device to perform steps of the method according to a claim 1.

11. A non-transitory machine-readable medium having a computer program stored thereon, which when executed by a set of one or more processors of a network device, causes the network device to perform steps of the method according to claim 1.
